(19) United States
(12) Patent Application Publication
(10) Pub. No.: US 2009/0090629 A1
(43) Pub. Date: Apr. 9, 2009

(54) CATHODIC ELECTRODEPOSITION COATING COMPOSITIONS

(76) Inventors: Gabriele Buettner, Ratingen (DE); Andreas Fieberg, Duesseldorf (DE); Carmen Flosbach, Wuppertal (DE); Thomas Grawe, Leverkusen (DE); Tanja Renkes, Essen (DE)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/281,807

(22) PCT Filed: Mar. 6, 2007
(86) PCT No.: PCT/US07/05895

§ 371 Date: Sep. 5, 2008

(51) Int. Cl. C25D 13/06; C08L 63/00

(52) U.S. Cl. 204/509; 524/540

(57) ABSTRACT

CED coating compositions which, apart from water, comprise (i) a resin solids content consisting of at least one film-forming, self- or externally cross-linking CED binder and the optional components: cross-linkers, paste resins, nonionic resins, and (ii) optionally, at least one component selected from the group consisting of pigments, fillers, coating additives and organic solvents, and contain relative to the resin solids content thereof, 1 to 20 wt. % of at least one resin A with functional groups selected from the group consisting of hydroxyl groups, free isocyanate groups and blocked isocyanate groups, wherein the at least one resin A is present as particles with melting temperatures from 40 to 200° C.

### FIELD OF THE INVENTION

The invention relates to cathodic electrodeposition coating compositions (CED coating compositions, CED coating agents).

### BACKGROUND OF THE INVENTION

CED coating compositions are used in particular to produce anti-corrosive primer layers on metal substrates. They may also be cathodically deposited and baked, for example, onto any electrically conductive substrates as a single-layer top coat, clear coat or as a coating layer which is arranged within a multilayer coating. A CED coating layer arranged within a multilayer coating may, for example, be a coating layer with decorative effect which acts as a top coat or to which a clear coat layer may further be applied.

A problem which arises when coating with CED coating compositions is edge migration when a CED coating layer previously deposited onto an electrically conductive substrate is baked. The CED coating film pulls away from the edge, reducing the film thickness at and/or in the immediate vicinity of the edge. In extreme circumstances the edge is not coated after baking. While in the case of decorative CED coatings this is perceived as a difference in color because of the substrate showing through in the region of the edge, in the case of anti-corrosive CED primers the corrosion protection is impaired or lost at and/or in the region of the edge. CED coating compositions thus often contain additives which enhance edge coverage or edge corrosion protection.

On the other hand, CED coating compositions with good edge coverage and thus good edge corrosion protection are generally distinguished in that the optical surface quality of coating layers produced therefrom is in need of improvement, i.e., the CED-coated surfaces are relatively rough. For example, such CED-coated surfaces provide a somewhat unfavorable base with regard to appearance of a subsequently applied coating of one or more coating layers. Conversely, CED coating compositions from which coatings with good optical surface quality may be produced often exhibit edge coverage which is in need of improvement. In other words, the properties of edge coverage and optical surface quality behave oppositely with regard to their quality, i.e., they are properties which require compromises to be made when selecting the composition of a CED coating composition.

The object of the invention is to provide CED coating compositions which exhibit slight or no edge migration behavior on baking of the coating layers cathodically deposited therefrom. The CED coatings applied from the CED coating compositions should simultaneously have good optical surface quality.

### SUMMARY OF THE INVENTION

The invention is directed to CED coating compositions which, apart from water, comprise (i) a resin solids content consisting of at least one film-forming, self- or externally cross-linking CED binder and the optional components: cross-linkers (cross-linking agents), paste resins (grinding resins), nonionic resins, and (ii) optionally, at least one component selected from the group consisting of pigments, fillers (extenders), coating additives and organic solvents, and contain relative to the resin solids content thereof, 1 to 20, preferably 5 to 15 wt. % of at least one resin A with functional groups selected from the group consisting of hydroxyl groups, free isocyanate groups and blocked isocyanate groups, wherein the at least one resin A is present as particles with melting temperatures from 40 to 200° C., in particular from 60 to 180° C.

### DETAILED DESCRIPTION OF THE EMBODIMENTS

The CED coating compositions according to the invention are aqueous coating compositions with a solids content of, for example, 10 to 30 wt. %. The solids content consists of the resin solids content, the content of the at least one resin A that is essential for the invention, and of the following optional components: fillers, pigments and/or other non-volatile coating additives. The at least one resin A does not count as a constituent of the resin solids content. The resin solids content itself consists of the CED binder(s), optionally present paste resins, optionally present cross-linkers and optionally present nonionic resins. All the constituents belonging to the resin solids content are either liquid and/or soluble in organic solvents. Paste resins are classed among the CED binders. The CED binders have cationic substituents and/or substituents which can be converted into cationic groups. The CED binders may be self-cross-linking or preferably, externally cross-linking, in the latter case they have groups capable of chemical cross-linking and the CED coating compositions then contain cross-linkers. The cross-linkers may also have cationic groups.

For example, the resin solids composition of the CED coating compositions is:

50 wt. % to 100 wt. % of CED binders,

0 wt. % to 40 wt. % of cross-linkers,

0 wt. % to 10 wt. % of nonionic resins.

The resin solids composition of the CED coating agents is preferably:

50 wt. % to 90 wt. % of externally cross-linking CED binders,

10 wt. % to 40 wt. % of cross-linkers,

0 wt. % to 10 wt. % of nonionic resins.

The CED binders' cationic groups or groups which can be converted into cationic groups may be, for example, basic groups, preferably basic groups containing nitrogen; these groups may be present in quaternized form or they are converted into cationic groups with a neutralizing agent conventional for CED coating compositions, such as, for example, lactic acid, formic acid, acetic acid, methanesulfonic acid. Examples are amino, ammonium, for example, quaternary ammonium, phosphonium and/or sulfonium groups. Amino groups present may be primary, secondary and/or tertiary. The groups which can be converted into cationic groups may be present in partially or wholly neutralized form.

The CED binders are preferably resins containing primary, secondary and/or tertiary amino groups and having amine values, for example, from 20 to 250 mg KOH/g. The weight average molar mass of the CED binders is preferably 300 to 10,000. As self-cross-linking or preferably externally cross-linking binders, the CED binders bear functional groups capable of chemical cross-linking, particularly hydroxyl groups, and have a hydroxyl value of, for example, 30 to 300, preferably 50 to 250 mg KOH/g. The CED binders may be converted to the aqueous phase after quaternization or neutralization of at least a part of the basic groups. Examples of CED binders include binders, such as, amino(meth)acrylic resins, aminopolyurethane resins, amino group-containing polybutadiene resins, epoxy resin-carbon dioxide-amine reaction products and, in particular, aminoepoxy resins, for example, aminoepoxy resins having terminal double bonds, aminoepoxy resins with primary OH groups.

The term “(meth)acryl” used in the present description and the claims means acryl and/or methacryl.

Examples of cross-linkers include aminoplastic resins (amine/formaldehyde resins), cross-linkers having terminal double bonds, cross-linkers having cyclic carbonate groups, polyepoxy compounds, cross-linkers containing groups capable of transesterification and/or transamidisation, and particularly polyisocyanates that are blocked with conventional blocking agents, such as, for example, monoalcohols, glycol ethers, ketoximes, lactams, malonic acid esters, acetoacetic acid esters.

All the number or weight average molar mass data stated in the present description are determined or to be determined by gel permeation chromatography (GPC; divinylbenzene-cross-linked polystyrene as the immobile phase, tetrahydrofuran as the liquid phase, polystyrene standards).

To produce the CED coating compositions the cationic binders may be used as CED binder dispersion which may optionally contain non-ionic binders and/or cross-linkers and/or, as explained below, the at least one resin A. CED binder dispersions may be produced by synthesis of CED binders in the presence or absence of organic solvents and conversion into an aqueous dispersion by diluting the neutralized CED binders with water. The CED binder(s) may be present in a mixture with one or more non-ionic resins and/or one or more suitable cross-linkers and/or the at least one resin A and be converted into the aqueous dispersion together with them. Where present, organic solvent may be removed down to the desired content, for example, by distillation in vacuo, before or after conversion into the aqueous dispersion. Subsequent removal of solvents may be avoided, for example, if the CED binders are neutralized in the low-solvent or solventless state, for example, as solventless melt, for example, at temperatures of up to 140° C. and then converted into the CED binder dispersion with water.

As mentioned above, the CED coating compositions may contain non-ionic resins. Examples of non-ionic resins are (meth)acrylic copolymer resins, polyester resins and polyurethane resins. The non-ionic resins preferably have functional groups, particularly cross-linkable functional groups. Particularly preferably they are the same cross-linkable functional groups as the CED binders of the CED coating compositions also contain. Preferred examples of such functional groups are hydroxyl groups. Accordingly the non-ionic resins are preferably polymer polyols.

The CED coating compositions according to the invention contain, relative to the resin solids content thereof, 1 to 20, preferably 5 to 15 wt. % of the at least one resin A with functional groups selected from the group consisting of hydroxyl groups, free isocyanate groups and blocked isocyanate groups, wherein the at least one resin A is present as particles with melting temperatures from 40 to 200° C., in particular from 60 to 180° C.

The resins A, which should not be confused either with the CED binders or with possible nonionic resins, comprise resins which are present in the CED coating compositions as particles and exhibit a melting temperature of 40 to 200° C., in particular of 60 to 180° C. The melting temperatures are not in general sharp melting points, but instead the upper end of melting ranges with a breadth of, for example, 30 to 150° C. The melting ranges and thus, the melting temperatures may be determined, for example, by DSC (differential scanning calorimetry) at heating rates of 10 K/min. The resin A particles are present in the CED coating compositions in particular within the generally aqueously dispersed CED binder phase or CED binder containing phase respectively.

The resins A are only very slightly, if at all, soluble in organic solvents conventional in coatings and/or in water, the solubility amounting, for example, to less than 10, in particular less than 5 g per litre of butyl acetate or water at 20° C.

Resins A with hydroxyl groups or blocked isocyanate groups are preferred. It is advantageous if the resins A can be involved in the chemical cross-linking process with their hydroxyl or free isocyanate or blocked isocyanate groups during thermal curing of the coating layers cathodically deposited from the CED coating compositions. In other words, those CED coating compositions having a CED binder/cross-linker system which allows for said involvement are preferred, in particular CED coating compositions which cross-link by the reaction of hydroxyl and/or secondary amino and/or primary amino groups with blocked isocyanate groups under formation of urethane and/or urea bonds.

In particular, the resins A are polyurethane resins with functional groups selected from the group consisting of hydroxyl groups, free isocyanate groups and blocked isocyanate groups.

The production of polyurethane resins A is known to the person skilled in the art; in particular, they may be produced by reacting polyol(s) with polyisocyanate(s) and, in case of isocyanate excess, reacting the excess free isocyanate groups with blocking agent(s). Polyols suitable for the production of the polyurethane resins A are not only polyols in the form of low molar mass compounds defined by empirical and structural formula but also oligomeric or polymeric polyols with number-average molar masses of, for example, up to 800, for example, corresponding hydroxyl-functional polyethers, polyesters or polycarbonates; low molar mass polyols defined by an empirical and structural formula are, however, preferred. The person skilled in the art selects the nature and proportion of the polyisocyanates, the polyols and the possible blocking agents for the production of polyurethane resins A in such a manner that polyurethane resins A with the above-mentioned melting temperatures and the above-mentioned solubility behavior are obtained.

The polyurethane resins A may be produced in the presence of a suitable organic solvent (mixture), which, however, makes it necessary to isolate the polyurethane resins A obtained in this manner or remove the solvent therefrom. Preferably, the production of the polyurethane resins A is, however, carried out without solvent and without subsequent purification operations.

In a first embodiment the polyurethane resins A are hydroxyl-functional polyurethane resins A. They may be produced, for example, by reacting polyisocyanate(s) with polyol(s) in the excess. The hydroxyl-functional polyurethane resins A have hydroxyl values of, for example, 50 to 300 mg KOH/g.

In a first preferred variant of the first embodiment, the hydroxyl-functional polyurethane resins A are polyurethane diols which can be prepared by reacting 1,6-hexane diisocyanate or 4,4′-diphenylmethane diisocyanate with a diol component in the molar ratio x:(x+1), wherein x means any desired value from 2 to 6, preferably, from 2 to 4, and the diol component is one single diol, in particular, one single diol with a molar mass in the range of 62 to 600, or a combination of diols, preferably two to four, in particular two or three diols, wherein in the case of a diol combination each of the diols preferably constitutes at least 10 mol % of the diols of the diol component.

The diisocyanate and the diol component are reacted stoichiometrically with one another in the molar ratio x mol diisocyanate:(x+1) mol diol compound(s), wherein x means any desired value from 2 to 6, preferably from 2 to 4.

One single diol, in particular, one single diol with a molar mass in the range of 62 to 600 is used as the diol component. It is also possible to use a combination of diols, preferably two to four, in particular two or three diols, wherein each of the diols preferably constitutes at least 10 mol % of the diols of the diol component.

In the case of the diol combination, the diol component may be introduced as a mixture of its constituent diols or the diols constituting the diol component may be introduced individually into the synthesis. It is also possible to introduce a proportion of the diols as a mixture and to introduce the remaining proportion or proportions in the form of pure diol. Each of the diols preferably constitutes at least 10 mol % of the diols of the diol component.

Examples of diols which are possible as one single diol of the diol component are bisphenol A and (cyclo)aliphatic diols, such as, ethylene glycol, the isomeric propane- and butanediols, 1,5-pentanediol, 1,6-hexanediol, 1,10-decanediol, 1,12-dodecanediol, 1,4-cyclohexanedimethanol, hydrogenated bisphenol A and dimer fatty alcohol.

The term “(cyclo)aliphatic” used in the description and the claims encompasses cycloaliphatic, linear aliphatic, branched aliphatic and cycloaliphatic with aliphatic residues. Diols differing from (cyclo)aliphatic diols, i.e., non-(cyclo)aliphatic diols, accordingly comprise aromatic or araliphatic diols with aromatically and/or aliphatically attached hydroxyl groups.

Examples of diols which are possible as constituents of the diol component are oligomeric or polymeric diols, such as, telechelic (meth)acrylic polymer diols, polyester diols, polyether diols, polycarbonate diols, each with a number-average molar mass of, for example, up to 800; low molar mass non-(cyclo)aliphatic diols defined by empirical and structural formula, such as bisphenol A; (cyclo)aliphatic diols defined by empirical and structural formula with a low molar mass in the range of 62 to 600, such as, ethylene glycol, the isomeric propane- and butanediols, 1,5-pentanediol, 1,6-hexanediol, 1,10-decanediol, 1,12-dodecanediol, neopentyl glycol, butylethylpropanediol, the isomeric cyclohexanediols, the isomeric cyclohexanedimethanols, hydrogenated bisphenol A, tricyclodecanedimethanol, and dimer fatty alcohol.

The diisocyanate and the diol component are preferably reacted together in the absence of solvents. The reactants may here all be reacted together simultaneously or in two or more synthesis stages. When the synthesis is performed in multiple stages, the reactants may be added in the most varied order, for example, also in succession or in alternating manner. The diol component may, for example, be divided into two or more portions or into the individual diols, for example, such that the diisocyanate is initially reacted with part of the diol component before further reaction with the remaining proportion of the diol component. The individual reactants may in each case be added in their entirety or in two or more portions. The reaction is exothermic and proceeds at a temperature above the melting temperature of the reaction mixture. The reaction temperature is, for example, 60 to 200° C. The rate of addition or quantity of reactants added is accordingly determined on the basis of the degree of exothermy and the liquid (molten) reaction mixture may be maintained within the desired temperature range by heating or cooling.

Once the reaction carried out in the absence of solvent is complete and the reaction mixture has cooled, solid polyurethane diols are obtained. When low molar mass diols defined by empirical and structural formula are used for synthesis of the polyurethane diols, their calculated molar masses are in the range of 522 or above, for example, up to 2200.

The polyurethane diols assume the form of a mixture exhibiting a molar mass distribution. The polyurethane diols do not, however, require working up and may be used directly as hydroxyl-functional polyurethane resins A.

In a second preferred variant of the first embodiment, the hydroxyl-functional polyurethane resins A are polyurethane diols which can be prepared by reacting a diisocyanate component and bisphenol A or a diol component in the molar ratio x:(x+1), wherein x means any desired value from 2 to 6, preferably, from 2 to 4, wherein 50 to 80 mol % of the diisocyanate component is formed by 1,6-hexane diisocyanate, and 20 to 50 mol % by one or two diisocyanates, each forming at least 10 mol % of the diisocyanate component and being selected from the group consisting of toluoylene diisocyanate, diphenylmethane diisocyanate, dicyclohexylmethane diisocyanate, isophorone diisocyanate, trimethylhexane diisocyanate, cyclohexane diisocyanate, cyclohexanedimethylene diisocyanate and tetramethylenexylylene diisocyanate, wherein the mol % of the respective diisocyanates add up to 100 mol %, wherein 20 to 100 mol % of the diol component is formed by at least one linear aliphatic alpha,omega-C2-C12-diol, and 0 to 80 mol % by at least one diol that is different from linear aliphatic alpha,omega-C2-C12-diols, wherein each diol of the diol component preferably forms at least 10 mol % within the diol component, and wherein the mol % of the respective diols add up to 100 mol %.

The diisocyanate component and the bisphenol A or the diol component are reacted stoichiometrically with one another in the molar ratio x mol diisocyanate:(x+1) mol diol compound(s), wherein x represents any value from 2 to 6, preferably from 2 to 4.

50 to 80 mol % of the diisocyanate component is formed by 1,6-hexane diisocyanate, and 20 to 50 mol % by one or two diisocyanates selected from the group consisting of toluoylene diisocyanate, diphenylmethane diisocyanate, dicyclohexylmethane diisocyanate, isophorone diisocyanate, trimethylhexane diisocyanate, cyclohexane diisocyanate, cyclohexanedimethylene diisocyanate and tetramethylenexylylene diisocyanate, wherein if two diisocyanates are selected, each diisocyanate forms at least 10 mol % of the diisocyanates of the diisocyanate component. Preferably, the diisocyanate or the two diisocyanates, forming in total 20 to 50 mol % of the diisocyanate component, are selected from dicyclohexylmethane diisocyanate, isophorone diisocyanate, trimethylhexane diisocyanate, cyclohexane diisocyanate, cyclohexanedimethylene diisocyanate and tetramethylenexylylene diisocyanate.

The diol component consists to an extent of 20 to 100 mol % of at least one linear aliphatic alpha,omega-C2-C12-diol and to an extent of 0 to 80 mol % of at least one diol differing from linear aliphatic alpha,omega-C2-C12-diols. The diol component preferably consists of no more than four different diols, in particular only of one to three diols. In the case of only one diol, it accordingly comprises a linear aliphatic alpha,omega-C2-C12-diol. In the case of a combination of two, three or four diols, the diol component consists to an extent of 20 to 100 mol %, preferably of 80 to 100 mol %, of at least one linear aliphatic alpha,omega-C2-C12-diol and to an extent of 0 to 80 mol %, preferably of 0 to 20 mol % of at least one diol differing from linear aliphatic alpha,omega-C2-C12-diols and preferably, also from alpha,omega-diols with more than 12 carbon atoms. The at least one diol differing from linear aliphatic alpha,omega-C2-C12-diols and preferably, also from alpha,omega-diols with more than 12 carbon atoms comprises in particular diols defined by empirical and structural formula and with a low molar mass in the range of 76 to 600. In the case of a diol combination, each diol preferably makes up at least 10 mol % of the diol component.

Preferably, the diol component does not comprise any diols that are different from linear aliphatic alpha,omega-C2-C12-diols, but rather consists of one to four, preferably, one to three, and in particular only one linear aliphatic alpha,omega-C2-C12-diol.

In the case of the diol combination, the diol component may be introduced as a mixture of its constituent diols or the diols constituting the diol component may be introduced individually into the synthesis. It is also possible to introduce a proportion of the diols as a mixture and to introduce the remaining proportion or proportions in the form of pure diol. Each of the diols preferably constitutes at least 10 mol % of the diols of the diol component.

Examples of linear aliphatic alpha,omega-C2-C12-diols that may be used as one single diol of the diol component or as constituents of the diol component are ethylene glycol, 1,3-propanediol, 1,4-butanediol, 1,5-pentanediol, 1,6-hexanediol, 1,10-decanediol and 1,12-dodecanediol.

Examples of diols that are different from linear aliphatic alpha,omega-C2-C12-diols and may be used in the diol component are oligomeric or polymeric diols, such as, telechelic (meth)acrylic polymer diols, polyester diols, polyether diols, polycarbonate diols, each with a number-average molar mass of, for example, up to 800; low molar mass non-(cyclo)aliphatic diols defined by empirical and structural formula, such as, bisphenol A; (cyclo)aliphatic diols defined by empirical and structural formula with a low molar mass in the range of 76 to 600, such as, those isomers of propanediol and butanediol that are different from the isomers of propanediol and butanediol specified in the preceding paragraph, as well as, neopentyl glycol, butyl ethyl propanediol, the isomeric cyclohexanediols, the isomeric cyclohexanedimethanols, hydrogenated bisphenol A, tricyclodecanedimethanol, and dimer fatty alcohol.

The diisocyanate component and the bisphenol A or the diol component are preferably reacted together in the absence of solvents. The reactants may here all be reacted together simultaneously or in two or more synthesis stages. When the synthesis is performed in multiple stages, the reactants may be added in the most varied order, for example, also in succession or in alternating manner. The bisphenol A or the diol component may, for example, be divided into two or more portions or into the individual diols, for example, such that the diisocyanates are initially reacted with part of the bisphenol A or of the diol component before further reaction with the remaining proportion of the bisphenol A or of the diol component. Equally, however, the diisocyanate component may also be divided into two or more portions or into the individual diisocyanates, for example, such that the hydroxyl components are initially reacted with part of the diisocyanate component and finally with the remaining proportion of the diisocyanate component. The individual reactants may in each case be added in their entirety or in two or more portions. The reaction is exothermic and proceeds at a temperature above the melting temperature of the reaction mixture. The reaction temperature is, for example, 60 to 200° C. The rate of addition or quantity of reactants added is accordingly determined on the basis of the degree of exothermy and the liquid (molten) reaction mixture may be maintained within the desired temperature range by heating or cooling.

Once the reaction carried out in the absence of solvent is complete and the reaction mixture has cooled, solid polyurethane diols are obtained. When low molar mass diols defined by empirical and structural formula are used for synthesis of the polyurethane diols, their calculated molar masses are in the range of 520 or above, for example, up to 2200.

The polyurethane diols assume the form of a mixture exhibiting a molar mass distribution. The polyurethane diols do not, however, require working up and may be used directly as hydroxyl-functional polyurethane resins A.

If, in individual cases, a proportion of the dihydroxy compound(s) used for the synthesis of those polyurethane diols according to the first or second preferred variant of the first embodiment stated above is replaced by a triol component comprising at least one triol, polyurethane resins A are obtained which are branched and/or more highly hydroxyl-functional compared to the respective polyurethane diols. Variants with such polyurethane resins A are themselves further preferred variants of the first embodiment. For example, up to 70% of the dihydroxy compound(s) in molar terms may be replaced by the triol(s) of the triol component. Examples of triols usable as constituent(s) of a corresponding triol component are trimethylolethane, trimethylolpropane and/or glycerol. Glycerol is preferably used alone as a triol component.

In a second embodiment the polyurethane resins A are isocyanate-functional polyurethane resins A. They may be produced by reacting polyol(s) with polyisocyanate(s) in the excess. The polyurethane resins A have isocyanate contents of, for example, 2 to 13.4 wt. % (calculated as NCO, molar mass 42).

In a first preferred variant of the second embodiment, the isocyanate-functional polyurethane resins A are polyurethane diisocyanates which can be prepared by reacting 1,6-hexane diisocyanate or 4,4′-diphenylmethane diisocyanate with a diol component in the molar ratio (x+1):x, wherein x means any desired value from 2 to 6, preferably, from 2 to 4, and the diol component is one single diol, in particular, one single diol with a molar mass in the range of 62 to 600, or a combination of diols, preferably two to four, in particular, two or three diols, wherein in the case of a diol combination each of the diols preferably constitutes at least 10 mol % of the diols of the diol component.

The diisocyanate and the diol component are reacted stoichiometrically with one another in the molar ratio (x+1) mol diisocyanate:x mol diol compound(s), wherein x means any desired value from 2 to 6, preferably from 2 to 4.

With regard to the nature and use of the diol component and to the diols possible as constituents, in order to avoid repetition, reference is made to the statements made in relation to the first preferred variant of hydroxyl-functional polyurethane resins A.

The diisocyanate and the diol component are preferably reacted together in the absence of solvents. With regard to the sequence of addition of the reactants and the reaction conditions, in order to avoid repetition, reference is made to the statements made in relation to the first preferred variant of hydroxyl-functional polyurethane resins A.

Once the reaction carried out in the absence of solvent is complete and the reaction mixture has cooled, solid polyurethane diisocyanates are obtained. When low molar mass diols defined by empirical and structural formula are used for synthesis of the polyurethane diisocyanates, their calculated molar masses are in the range of 628 or above, for example, up to 2300.

The polyurethane diisocyanates assume the form of a mixture exhibiting a molar mass distribution. The polyurethane diisocyanates do not, however, require working up and may be used directly as isocyanate-functional polyurethane resins A.

In a second preferred variant of the second embodiment, the isocyanate-functional polyurethane resins A are polyurethane diisocyanates which can be prepared by reacting a diisocyanate component and bisphenol A or a diol component in the molar ratio (x+1):x, wherein x means any desired value from 2 to 6, preferably, from 2 to 4, wherein 50 to 80 mol % of the diisocyanate component is formed by 1,6-hexane diisocyanate, and 20 to 50 mol % by one or two diisocyanates, each forming at least 10 mol % of the diisocyanate component and being selected from the group consisting of toluoylene diisocyanate, diphenylmethane diisocyanate, dicyclohexylmethane diisocyanate, isophorone diisocyanate, trimethylhexane diisocyanate, cyclohexane diisocyanate, cyclohexanedimethylene diisocyanate and tetramethylenexylylene diisocyanate, wherein the mol % of the respective diisocyanates add up to 100 mol %, wherein 20 to 100 mol % of the diol component is formed by at least one linear aliphatic alpha,omega-C2-C12-diol, and 0 to 80 mol % by at least one diol that is different from linear aliphatic alpha,omega-C2-C12-diols, wherein each diol of the diol component preferably forms at least 10 mol % within the diol component, and wherein the mol % of the respective diols add up to 100 mol %.

The diisocyanate component and the bisphenol A or the diol component are reacted stoichiometrically with one another in the molar ratio (x+1) mol diisocyanate:x mol diol compound(s), wherein x represents any value from 2 to 6, preferably from 2 to 4.

With regard to the nature of the diisocyanate component, the nature and the use of the diol component and to the diols possible as constituents, in order to avoid repetition, reference is made to the statements made in relation to the second preferred variant of hydroxyl-functional polyurethane resins A.

The diisocyanates of the diisocyanate component and the bisphenol A or the diol(s) of the diol component are preferably reacted together in the absence of solvents. With regard to the sequence of addition of the reactants and the reaction conditions, in order to avoid repetition, reference is made to the statements made in relation to the second preferred variant of hydroxyl-functional polyurethane resins A.

Once the reaction carried out in the absence of solvent is complete and the reaction mixture has cooled, solid polyurethane diisocyanates are obtained. When low molar mass diols defined by empirical and structural formula are used for synthesis of the polyurethane diisocyanates, their calculated molar masses are in the range of 625 or above, for example, up to 2300.

The polyurethane diisocyanates assume the form of a mixture exhibiting a molar mass distribution. The polyurethane diisocyanates do not, however, require working up and may be used directly as isocyanate-functional polyurethane resins A.

In a third preferred variant of the second embodiment, the isocyanate-functional polyurethane resins A are polyurethane polyisocyanates which can be prepared by reacting a trimer of a (cyclo)aliphatic diisocyanate, 1,6-hexane diisocyanate and bisphenol A or a diol component in the molar ratio 1:x:x, wherein x means any desired value from 1 to 6, preferably, from 1 to 3, wherein the diol component is one single linear aliphatic alpha,omega-C2-C12-diol or a combination of two to four, preferably, two or three, diols, wherein in the case of a diol combination, each of the diols makes up at least 10 mol % of the diols of the diol combination and the diol combination consists of at least 80 mol % of bisphenol A or of at least one linear aliphatic alpha,omega-C2-C12-diol.

The trimer of the (cyclo)aliphatic diisocyanate, the 1,6-hexane diisocyanate and the bisphenol A or the diol component are reacted stoichiometrically with one another in the molar ratio 1 mol trimer of the (cyclo)aliphatic diisocyanate:x mol 1,6-hexane diisocyanate:x mol diol compound(s), wherein x represents any value from 1 to 6, preferably from 1 to 3.

The trimer of the (cyclo)aliphatic diisocyanate is polyisocyanates of the isocyanurate type, prepared by trimerization of a (cyclo)aliphatic diisocyanate. Appropriate trimerization products derived, for example, from 1,4-cyclohexanedimethylenediisocyanate, in particular, from isophorone diisocyanate and more particularly, from 1,6-hexane diisocyanate, are suitable. The industrially obtainable isocyanurate polyisocyanates generally contain, in addition to the pure trimer, i.e., the isocyanurate made up of three diisocyanate molecules and comprising three NCO functions, isocyanate-functional secondary products with a relatively high molar mass. Products with the highest possible degree of purity are preferably used. In each case, the trimers of the (cyclo)aliphatic diisocyanates obtainable in industrial quality are regarded as pure trimer irrespective of their content of said isocyanate-functional secondary products with respect to the molar ratio of 1 mol trimer of the (cyclo)aliphatic diisocyanate:x mol 1,6-hexane diisocyanate:x mol diol compound(s).

One single linear aliphatic alpha,omega-C2-C12-diol or combinations of two to four, preferably of two or three, diols are used as the diol component.

Examples of one single linear aliphatic alpha,omega-C2-C12-diol or linear aliphatic alpha,omega-C2-C12-diols which can be used within the diol combination are ethylene glycol, 1,3-propanediol, 1,4-butanediol, 1,5-pentanediol, 1,6-hexanediol, 1,10-decanediol, 1,12-dodecanediol.

Examples of (cyclo)aliphatic diols which can be used within the diol combination in addition to the bisphenol A making up at least 80 mol % of the diol combination or the at least one linear aliphatic alpha,omega-C2-C12-diol making up at least 80 mol % of the diol combination are the further isomers of propane and butane diol, different from the isomers of propane and butane diol cited in the preceding paragraph, and neopentylglycol, butylethylpropanediol, the isomeric cyclohexane diols, the isomeric cyclohexanedimethanols, hydrogenated bisphenol A and tricyclodecanedimethanol.

In the case of the diol combination, the mixture of the dihydroxy compounds making up the combination can be used in the synthesis process or the dihydroxy compounds making up the diol combination are each used individually in the synthesis. It is also possible to use a portion of the diols as a mixture and the remaining fraction(s) in the form of pure diol.

In the case of the diol combination, preferred diol combinations totalling 100 mol % in each case are combinations of 10 to 90 mol % 1,3-propanediol with 90 to 10 mol % 1,5-pentanediol, 10 to 90 mol % 1,3-propanediol with 90 to 10 mol % 1,6-hexanediol and 10 to 90 mol % 1,5-pentanediol with 90 to 10 mol % 1,6-hexanediol.

The trimer of the (cyclo)aliphatic diisocyanate, the 1,6-hexane-diisocyanate and the bisphenol A or the diol component are preferably reacted together in the absence of solvents. The reactants may here all be reacted together simultaneously or in two or more synthesis stages. Synthesis procedures in which the bisphenol A or the diol component and the trimer of the (cyclo)aliphatic diisocyanate alone are reacted with one another are preferably avoided.

When the synthesis is performed in multiple stages, the reactants may be added in the most varied order, for example, also in succession or in alternating manner. For example, the 1,6-hexane diisocyanate may be reacted initially with the bisphenol A or with the diol component and then with the trimer of the (cyclo)aliphatic diisocyanate or a mixture of the isocyanate-functional components with the bisphenol A or with the diol component. In the case of a diol combination, the diol component may, for example, also be divided into two or more portions, for example, also into the individual dihydroxy compounds. The individual reactants may in each case be added in their entirety or in two or more portions. The reaction is exothermic and proceeds at a temperature above the melting temperature of the reaction mixture. The reaction temperature is, for example, 60 to 200° C. The rate of addition or quantity of reactants added is accordingly determined on the basis of the degree of exothermy and the liquid (molten) reaction mixture may be maintained within the desired temperature range by heating or cooling.

Once the reaction carried out in the absence of solvents is complete and the reaction mixture has cooled, solid polyurethane polyisocyanates with number average molar masses in the range of 1,500 to 4,000 are obtained. The polyurethane polyisocyanates do not require working up and may be used directly as isocyanate-functional polyurethane resins A.

In a third embodiment the polyurethane resins A are polyurethane resins A with blocked isocyanate groups. They may be produced by reacting polyol(s) with polyisocyanate(s) in excess and reacting the excess free isocyanate groups with one or more monofunctional blocking agents. The latent isocyanate content of the polyurethane resins A with blocked isocyanate groups is, for example, in the range from 2 to 21.2 wt. %, calculated as NCO and relative to the corresponding underlying polyurethane resins, i.e., which are free of blocking agent(s).

In a first preferred variant of the third embodiment, the polyurethane resins A have two blocked isocyanate groups per molecule and can be prepared by reacting 1,6-hexane diisocyanate or 4,4′-diphenylmethane diisocyanate with a diol component and with at least one monofunctional blocking agent in the molar ratio x:(x−1):2, wherein x means any desired value from 2 to 6, preferably, from 2 to 4, and the diol component is one single diol, in particular, one single diol with a molar mass in the range of 62 to 600, or a combination of diols, preferably two to four, in particular, two or three diols, wherein, in the case of a diol combination each of the diols preferably constitutes at least 10 mol % of the diols of the diol component.

The diisocyanate, the diol component and the at least one monofunctional blocking agent are reacted stoichiometrically with one another in the molar ratio x mol diisocyanate:(x−1) mol diol compound(s):2 mol blocking agent, wherein x means any desired value from 2 to 6, preferably from 2 to 4.

With regard to the nature and use of the diol component and to the diols possible as constituents, in order to avoid repetition, reference is made to the statements made in relation to the first preferred variant of hydroxyl-functional polyurethane resins A.

Preferably, only one monofunctional blocking agent is used. Examples of the at least one monofunctional blocking agent are the monofunctional compounds known for blocking isocyanate groups, such as, the CH-acidic, NH-, SH- or OH-functional compounds known for this purpose. Examples are CH-acidic compounds, such as, acetylacetone or CH-acidic esters, such as, acetoacetic acid alkyl esters, malonic acid dialkyl esters; aliphatic or cycloaliphatic alcohols, such as, n-butanol, 2-ethylhexanol, cyclohexanol; glycol ethers, such as, butyl glycol, butyl diglycol; phenols; oximes, such as, methyl ethyl ketoxime, acetone oxime, cyclohexanone oxime; lactams, such as, caprolactam; azole blocking agents of the imidazole, pyrazole, triazole or tetrazole type.

The diisocyanate, the diol component and the at least one monofunctional blocking agent are preferably reacted together in the absence of solvents. The reactants may here all be reacted together simultaneously or in two or more synthesis stages. When the synthesis is performed in multiple stages, the reactants may be added in the most varied order, for example, also in succession or in alternating manner. For example, the diisocyanate may be reacted initially with blocking agent and then with the diol(s) of the diol component or initially with the diol(s) of the diol component and then with blocking agent. However, the diol component may, for example, also be divided into two or more portions, for example, also into the individual diols, for example, such that the diisocyanate is reacted initially with part of the diol component before further reaction with blocking agent and finally with the remaining proportion of the diol component. The individual reactants may in each case be added in their entirety or in two or more portions. The reaction is exothermic and proceeds at a temperature above the melting temperature of the reaction mixture. The reaction temperature is, for example, 60 to 200° C. The rate of addition or quantity of reactants added is accordingly determined on the basis of the degree of exothermy and the liquid (molten) reaction mixture may be maintained within the desired temperature range by heating or cooling.

Once the reaction carried out in the absence of solvent is complete and the reaction mixture has cooled, solid polyurethanes with two blocked isocyanate groups per molecule are obtained. When low molar mass diols defined by empirical and structural formula are used for synthesis of the polyurethanes with two blocked isocyanate groups per molecule their molar masses calculated with the example of butanone oxime as the only blocking agent used are in the range of 572 or above, for example, up to 2000.

The polyurethanes with two blocked isocyanate groups per molecule assume the form of a mixture exhibiting a molar mass distribution. The polyurethanes with two blocked isocyanate groups per molecule do not, however, require working up and may be used directly as blocked isocyanate-functional polyurethane resins A.

In a second preferred variant of the third embodiment, the polyurethane resins A have two blocked isocyanate groups per molecule and can be prepared by reacting a diisocyanate component, bisphenol A or a diol component and at least one monofunctional blocking agent in the molar ratio x:(x−1):2, wherein x means any desired value from 2 to 6, preferably, from 2 to 4, wherein 50 to 80 mol % of the diisocyanate component is formed by 1,6-hexane diisocyanate, and 20 to 50 mol % by one or two diisocyanates, each forming at least 10 mol % of the diisocyanate component and being selected from the group consisting of toluoylene diisocyanate, diphenylmethane diisocyanate, dicyclohexylmethane diisocyanate, isophorone diisocyanate, trimethylhexane diisocyanate, cyclohexane diisocyanate, cyclohexanedimethylene diisocyanate and tetramethylenexylylene diisocyanate, wherein the mol % of the respective diisocyanates add up to 100 mol %, wherein 20 to 100 mol % of the diol component is formed by at least one linear aliphatic alpha,omega-C2-C12-diol, and 0 to 80 mol % by at least one diol that is different from linear aliphatic alpha,omega-C2-C12-diols, wherein each diol of the diol component preferably forms at least 10 mol % within the diol component, and wherein the mol % of the respective diols add up to 100 mol %.

The diisocyanate component, the bisphenol A or the diol component and the at least one monofunctional blocking agent are reacted stoichiometrically with one another in the molar ratio x mol diisocyanate:(x−1) mol diol compound(s):2 mol blocking agent, wherein x represents any value from 2 to 6, preferably from 2 to 4.

With regard to the nature of the diisocyanate component, the nature and the use of the diol component and to the diols possible as constituents, in order to avoid repetition, reference is made to the statements made in relation to the second preferred variant of hydroxyl-functional polyurethane resins A.

Preferably, only one monofunctional blocking agent is used. Examples of the at least one monofunctional blocking agent are the same as those listed above as examples in relation to the first preferred variant of polyurethane resins A with blocked isocyanate groups.

The diisocyanate component, the bisphenol A or the diol component and the at least one monofunctional blocking agent are preferably reacted together in the absence of solvents. The reactants may here all be reacted together simultaneously or in two or more synthesis stages. When the synthesis is performed in multiple stages, the reactants may be added in the most varied order, for example, also in succession or in alternating manner. For example, the diisocyanates of the diisocyanate component may be reacted initially with blocking agent and then with the bisphenol A or with the diol(s) of the diol component or initially with the bisphenol A or with the diol component and then with blocking agent. However, the bisphenol A or the diol component may, for example, also be divided into two or more portions, for example, also into the individual diols, for example, such that the diisocyanate component is reacted initially with part of the bisphenol A or of the diol component before further reaction with blocking agent and finally with the remaining proportion of the bisphenol A or of the diol component. In a very similar manner, however, the diisocyanate component may, for example, also be divided into two or more portions, for example, also into the individual diisocyanates, for example, such that the bisphenol A or the diol component and blocking agent are reacted initially with part of the diisocyanate component and finally with the remaining proportion of the diisocyanate component. The individual reactants may in each case be added in their entirety or in two or more portions. The reaction is exothermic and proceeds at a temperature above the melting temperature of the reaction mixture. The reaction temperature is, for example, 60 to 200° C. The rate of addition or quantity of reactants added is accordingly determined on the basis of the degree of exothermy and the liquid (molten) reaction mixture may be maintained within the desired temperature range by heating or cooling.

Once the reaction carried out in the absence of solvent is complete and the reaction mixture has cooled, solid polyurethanes with two blocked isocyanate groups per molecule are obtained. When low molar mass diols defined by empirical and structural formula are used for synthesis of the polyurethanes with two blocked isocyanate groups per molecule, their molar masses calculated with the example of butanone oxime as the only blocking agent used are in the range of 570 or above, for example, up to 2000.

The polyurethanes with two blocked isocyanate groups per molecule assume the form of a mixture exhibiting a molar mass distribution. The polyurethanes with two blocked isocyanate groups per molecule do not, however, require working up and may be used directly as blocked isocyanate-functional polyurethane resins A.

In a third preferred variant of the third embodiment, the polyurethane resins A are polyurethanes with blocked isocyanate groups and can be prepared by reacting a trimer of a (cyclo)aliphatic diisocyanate, 1,6-hexane diisocyanate, bisphenol A or a diol component and at least one monofunctional blocking agent in the molar ratio 1:x:x:3, wherein x means any desired value from 1 to 6, preferably, from 1 to 3, wherein the diol component is one single linear aliphatic alpha,omega-C2-C12-diol or a combination of two to four, preferably, two or three, diols, wherein in the case of diol combination, each of the diols makes up at least 10 mol % of the diols of the diol combination and the diol combination consists of at least 80 mol % of bisphenol A or of at least one linear aliphatic alpha,omega-C2-C12-diol.

The trimer of the (cyclo)aliphatic diisocyanate, the 1,6-hexane diisocyanate, the bisphenol A or the diol component and the at least one monofunctional blocking agent are reacted stoichiometrically with one another in the molar ratio 1 mol trimer of the (cyclo)aliphatic diisocyanate:x mol 1,6-hexane diisocyanate:x mol diol compound(s):3 mol blocking agent, wherein x represents any value from 1 to 6, preferably from 1 to 3.

With regard to the nature of the trimer of the (cyclo)aliphatic diisocyanate, the nature and the use of the diol component and to the diols possible as constituents, in order to avoid repetition, reference is made to the statements made in relation to the third preferred variant of isocyanate-functional polyurethane resins A.

Preferably, only one monofunctional blocking agent is used. Examples of the at least one monofunctional blocking agent are the same as those listed above as examples in relation to the first preferred variant of polyurethane resins A with blocked isocyanate groups.

The trimer of the (cyclo)aliphatic diisocyanate, the 1,6-hexane diisocyanate, the bisphenol A or the diol component and the at least one monofunctional blocking agent are preferably reacted together in the absence of solvents. The reactants may here all be reacted together simultaneously or in two or more synthesis stages. Synthesis procedures in which the blocking agent or the bisphenol A or the diol component and the trimer of the (cyclo)aliphatic diisocyanate alone are reacted with one another are preferably avoided.

When the synthesis is performed in multiple stages, the reactants may be added in the most varied order, for example, also in succession or in alternating manner. For example, the 1,6-hexane diisocyanate may be reacted initially with a mixture of the bisphenol A or of the diol component and the blocking agent and then with the trimer of the (cyclo)aliphatic diisocyanate or a mixture of the isocyanate-functional components with the bisphenol A or the diol component and the blocking agent or a mixture of the isocyanate-functional components may be reacted initially with blocking agent and then with the bisphenol A or the diol component. In the case of a diol combination, the diol component may, for example, also be divided into two or more portions, for example, also into the individual dihydroxy compounds. The individual reactants may in each case be added in their entirety or in two or more portions. The reaction is exothermic and proceeds at a temperature above the melting temperature of the reaction mixture. The reaction temperature is, for example, 60 to 200° C. The rate of addition or quantity of reactants added is accordingly determined on the basis of the degree of exothermy and the liquid (molten) reaction mixture may be maintained within the desired temperature range by heating or cooling.

Once the reaction carried out in the absence of solvents is complete and the reaction mixture has cooled, solid polyurethanes with blocked isocyanate groups and with number average molar masses in the range of 1,500 to 4,000 are obtained. The polyurethanes with blocked isocyanate groups do not require working up and may be used directly as blocked isocyanate-functional polyurethane resins A.

If, during the preparation of polyurethane resins A according to the third embodiment, monoalcohols with one or more, in particular one tertiary amino group, such as, for example, N,N-dimethylethanol amine, N,N-dimethylisopropanol amine or N,N-dimethyl-2-(2-aminoethoxy)ethanol are used instead of the monofunctional blocking agents, polyurethane resins with tertiary amino groups usable as resins A in CED coating compositions are obtained.

The at least one resin A is present in particulate form, in particular, in the form of particles with a non-spherical shape, in the CED coating compositions, in particular within the generally aqueously dispersed CED binder phase or CED binder containing phase respectively. The average particle size (mean particle diameter) of the resin A particles determined by means of laser diffraction is, for example, 1 to 100 μm. The resin A particles may be formed by grinding (milling) of the solid resin(s) A; for example, conventional powder coat production technology may be used for that purpose. The resin A particles may either be stirred or mixed as a ground powder into the CED binder not yet converted into the aqueous phase or into a non-aqueous paste resin, wherein it is possible subsequently to perform additional wet grinding or dispersing of the resin A particles, for example, by means of a bead mill, in the resultant suspension.

A further method for forming the resin A particles involves hot dissolution of the at least one resin A in a dissolution medium and subsequent resin A particle formation during and/or after cooling. Dissolution of the at least one resin A may be performed in particular in a proportion or the entirety of the CED binder(s) with heating, for example, to the melting temperature or above, for example, to temperatures of 40 to above 200° C., whereupon the resin A particles may form during and/or after the subsequent cooling. The CED binder used as dissolution medium for the at least one resin A may here be present liquid as such or as a solution in an organic solvent (mixture). Thorough mixing or stirring is preferably performed during cooling. Dissolution of the at least one resin A may also be performed with heating in an organic solvent (mixture), wherein the formation of the resin A particles, which proceeds during and/or after the subsequent cooling, may proceed in the solvent itself. Here it is also possible to allow the formation of the resin A particles after mixing of the resultant, as yet uncooled solution with the CED binder. By using the method of hot dissolution and subsequent resin A particle formation during and/or after cooling, it is in particular possible to produce resin A particles with average particle sizes at the lower end of the range of average particle sizes, for example, in the range of 1 to 50 μm, in particular 1 to 30 μm.

In addition to the resin solids content, water and the content of the at least one resin A that is essential for the invention, the CED coating compositions may contain pigments, fillers, solvents and/or coating additives.

Examples of pigments are the conventional inorganic and/or organic colored pigments and/or special effect pigments, such as, titanium dioxide, iron oxide pigments, carbon black, phthalocyanine pigments, quinacridone pigments, metal pigments, such as, for example, titanium, aluminium or copper pigments, interference pigments, such as, for example, titanium dioxide-coated aluminium, coated mica, platelet-like iron oxide, platelet-like copper phthalocyanine pigments. Examples of fillers are kaolin, talcum or silicon dioxide. The CED coating agents may also contain anti-corrosive pigments, such as, for example, zinc phosphate or organic corrosion inhibitors. The type and quantity of the pigments depends on the proposed application of the CED coating agents. If clear coatings are to be obtained, then no or only transparent pigments, such as, for example, micronized titanium dioxide or silicon dioxide are used. If opaque coatings are to be obtained, then the CED coating composition preferably contains coloring pigments.

The pigments and/or fillers may be dispersed in a portion of the non-aqueous CED binder and then ground in suitable equipment, for example, a pearl mill, after which completion takes place by mixing with the remaining proportion of CED binder. After addition of neutralizing agent—if this has not already taken place—the CED coating composition or bath may then be produced from this material by dilution with water (one-component method).

Pigmented CED coating compositions or baths may also be prepared by mixing a CED binder dispersion and a separately prepared pigment paste (two-component method). To this end, for example, a CED binder dispersion is diluted further with water and an aqueous pigment paste is then added. Aqueous pigment pastes are prepared by methods known to the skilled person, preferably by dispersing the pigments and/or fillers in paste resins conventionally used for these purposes and known to the skilled person. Examples of paste resins which can be used in CED coating compositions are described, for example, in EP-A-0 183 025 and EP-A-0 469 497.

The pigment plus filler/resin solids weight ratio of the CED coating compositions is, for example, 0:1 to 0.8:1; for pigmented CED coating compositions it is preferably from 0.05:1 to 0.4:1.

The CED coating compositions may contain additives conventional in coatings, for example, in quantity proportions from 0.1 wt. % to 5 wt. %, based on the resin solids. These are, in particular, those of the kind known for CED coating compositions, for example, wetting agents, neutralizing agents, leveling agents, catalysts, corrosion inhibitors, antifoaming agents, light stabilizers, antioxidants and anti-cratering additives. The additives may be introduced into the CED coating compositions in any manner, for example, during binder synthesis, during the preparation of the CED binder dispersions, by way of a pigment paste, or separately.

The CED coating compositions may contain conventional solvents in conventional proportions of, for example, 0 to 5 wt. %, based on the CED coating bath ready for coating. Examples of such solvents include glycol ethers, such as, butyl glycol and ethoxy propanol, and alcohols, such as, butanol. The solvents may be introduced into the CED coating compositions in any manner, for example, as a constituent of CED binder or cross-linker solutions, by way of a CED binder dispersion, as a constituent of a pigment paste or by separate addition.

As mentioned above, the CED coating compositions may be prepared by the known methods for the preparation of CED coating baths, i.e., in principle both by means of the one-component and by means of the two-component method described above.

During the preparation of the CED coating compositions by the one-component method, it is possible, for example, to operate in such a way that the at least one resin A is present in the presence of non-aqueous constituents of the CED coating composition, in particular in the presence of the non-aqueous CED binder(s) and is converted with these to the aqueous phase by dilution with water. In the case of pigmented CED coating compositions, the process steps described above in relation to the one-component method may be performed, i.e., pigments and/or fillers may be dispersed in a portion of the non-aqueous CED binder containing the at least one resin A and optionally cross-linker and optionally nonionic resin, then be ground, after which completion takes place by mixing with the remaining proportion of the CED binder. The at least one resin A may be contained in the CED binder used for dispersing and/or for completion. Thereafter the CED coating composition or bath may be prepared—after the addition of neutralizing agent, unless this has already been done—by dilution with water. If the above mentioned method of hot dissolution is used for the formation of the resin A particles, the resin A particle formation may happen prior to and/or after dilution with water; in any case however, resin A particle formation happens within the CED binder phase or the CED binder containing phase respectively.

During the preparation of the CED coating compositions by the two-component method, it is also possible to operate in such a way that the at least one resin A is present in the presence of the non-aqueous CED binder(s) and is converted together with these to the aqueous phase—after the addition of neutralizing agent, unless this has already been done—by dilution with water. A CED binder dispersion containing the at least one resin A is thus obtained. A pigmented CED coating composition or bath may then be prepared from the CED binder dispersion thus obtained by mixing with a separate pigment paste. Alternatively, if the two-component method is used, it is also possible to operate in such a way that an aqueous pigment paste containing the at least one resin A is added to a CED binder dispersion. The latter paste may be prepared, for example, by preparation of a non-aqueous paste resin containing the at least one resin A, conversion into an aqueous paste resin and dispersing of pigments and/or fillers in its presence.

The at least one resin A may also be added separately to the CED coating compositions, for example, as a corrective additive. For example, it is also possible to carry out the separate addition afterwards to CED coating baths ready for coating. The at least one resin A may be used as an organic or aqueous preparation. The at least one resin A may, for example, be a constituent of a non-aqueous, but already neutralized paste resin and be added this way to the CED coating bath. However, the at least one resin A may also initially be converted into a water-thinnable form; for example, the separate, in particular subsequent addition may happen as a constituent of an aqueous pigment paste, or the at least one resin A may be added as a constituent of a CED binder dispersion or in an aqueous paste resin.

CED coating layers may be deposited in the usual way from the CED coating compositions, for example, in a dry layer thickness of 10 to 30 μm, onto electrically conductive, for example, metallic substrates connected as the cathode, and baked at object temperatures above the melting temperature of the resin(s) A contained in the corresponding CED coating composition, for example, at 100 to 220° C. preferably, 100 to 190° C. If the difference between the melting temperature and the actual bake curing temperature is sufficiently large, it is possible initially to effect only or substantially only the melting of the resin A particles, before the actual crosslinking subsequently proceeds during and/or after a further increase in temperature to the curing temperature. During and/or after melting the resin A particles the resin A may become incorporated into the resin matrix. The CED coating layers may be applied and baked, for example, as a single layer coating or as a coating layer within a multilayer coating. The CED coating compositions according to the invention are particularly suitable in the automotive sector, in particular for the anti-corrosive priming of automotive parts, automotive bodies or automotive body parts. The CED primer layers may optionally be provided with further coating layers. The CED coating compositions according to the invention may, however, also be cathodically deposited and baked, for example, as a top coat, a clear coat or as a coating layer which is arranged within a multilayer coating and may have a decorative function.

In particular, the CED coating layers applied as a primer may be provided prior to or after baking with one or more further coating layers, for example, a top coat layer or a multilayer coating consisting of a primer surfacer or a primer surfacer substitute layer, a base coat layer and a clear coat layer.

The CED coating compositions according to the invention are distinguished by a distinctly reduced edge migration behavior or even no edge migration when the CED coating films deposited from them are baked. The optical surface quality of the baked CED coating films is good, i.e., the CED coating film surface exhibits a low roughness. In general, the CED coating compositions are more resistant towards crater formation within the CED coating films cathodically deposited from them compared to corresponding CED coating compositions free of the at least one resin A.

### EXAMPLES

### Examples 1a to 1d

### Preparation of Polyurethanes with Two Blocked Isocyanate Groups

Polyurethanes with two blocked isocyanate groups were produced by reacting 1,6-hexane diisocyanate with diols and butanone oxime in accordance with the following general synthesis method:

1,6-hexane diisocyanate (HDI) was initially introduced into a 2 litre four-necked flask equipped with a stirrer, thermometer and column and 0.01 wt. % dibutyltin dilaurate, relative to the initially introduced quantity of HDI, were added. The reaction mixture was heated to 60° C. Butanone oxime was then apportioned in such a manner that the temperature did not exceed 80° C. The reaction mixture was stirred at 80° C. until the theoretical NCO content had been reached. Once the theoretical NCO content had been reached, the diols A, B, C were added one after the other, in each case in a manner such that a temperature of 140° C. was not exceeded. In each case, the subsequent diol was not added until the theoretical NCO content had been reached. The reaction mixture was stirred at a maximum of 140° C. until no free isocyanate could be detected. The hot melt was then discharged and allowed to cool and solidify.

The resultant solid polyurethanes with two blocked isocyanates were in each case comminuted, ground and sieved by means of grinding and sieving methods conventional for the production of powder coatings and, in this manner, converted into binder powders with an average particle size of 20 μm (determined by means of laser diffraction).

The melting behavior of the polyurethanes with two blocked isocyanate groups was investigated by means of DSC (differential scanning calorimetry, heating rate 10 K/min).

Examples 1a to 1d are shown in Table 1. The Table states which reactants were reacted together in what molar ratios and the final temperature of the melting process measured by DSC is stated in ° C.

TABLE 1

| | | Mols | | | | |
|---|---|---|---|---|---|---|
| | Mols | butanone | Mols | Mols | Mols | |
| Example | HDI | oxime | diol A | diol B | diol C | FT |
| 1a | 3 | 2 | 1 PROP | 1 HEX | | 125° C. |
| 1b | 3 | 2 | 2 PENT | | | 127° C. |
| 1c | 4 | 2 | 1 PENT | 1 PROP | 1 HEX | 113° C. |
| 1d | 3 | 2 | 1 PENT | 1 HEX | | 114° C. |

FT: Final temperature of the melting process
HEX: 1,6-hexanediol
PENT: 1,5-pentanediol
PROP: 1,3-propanediol

### Examples 2a to 2d

### Preparation of Polyurethanes with Blocked Isocyanate Groups

Polyurethanes with blocked isocyanate groups were produced by reacting t-HDI (trimeric hexanediisocyanate; Desmodur® N3600 from Bayer), HDI, a diol component and butanone oxime in accordance with the following general synthesis method:

A mixture of t-HDI and HDI was initially introduced into a 2 litre four-necked flask equipped with a stirrer, thermometer and column and 0.01% by weight dibutyl tin dilaurate, based on the quantity of isocyanate introduced, were added. The reaction mixture was heated to 60° C. A mixture of butanone oxime and diol(s) was then added such that 140° C. was not exceeded. The temperature was carefully increased to a maximum of 140° C. and the mixture stirred until no more free isocyanate could be detected. The hot melt was then discharged and allowed to cool and solidify.

The resultant solid polyurethanes with blocked isocyanate groups were in each case comminuted, ground and sieved by means of grinding and sieving methods conventional for the production of powder coatings and, in this manner, converted into binder powders with an average particle size of 20 μm (determined by means of laser diffraction).

The melting behavior of the polyurethanes with blocked isocyanate groups was investigated by means of DSC (heating rate 10 K/min).

Examples 2a to 2d are shown in Table 2. The table states which reactants were reacted together and in which molar ratios and the final temperature of the melting process measured using DSC is indicated in ° C.

TABLE 2

| | | | Mols of | | | |
|---|---|---|---|---|---|---|
| | Mols of t- | Mols | butanone | Mols of | Mols of | |
| Example | HDI | of HDI | oxime | diol A | diol B | FT |
| 2a | 1 | 3 | 3 | 3 PROP | | 112° C. |
| 2b | 1 | 3 | 3 | 3 HEX | | 122° C. |
| 2c | 1 | 2 | 3 | 1 PROP | 1 HEX | 102° C. |
| 2d | 1 | 2 | 3 | 2 HEX | | 118° C. |

cf. Table 1 for abbreviations

### Examples 3a to 3

### Preparation of Polyurethane Diols

Polyurethane diols were produced by reacting HDI (1,6-hexane diisocyanate) or a mixture of HDI and DCMDI (dicyclohexylmethane diisocyanate) with one or more diols in accordance with the following general synthesis method:

One diol or a mixture of diols was initially introduced into a 2 litre four-necked flask equipped with a stirrer, thermometer and column and 0.01 wt. % dibutyltin dilaurate, relative to the initially introduced quantity of diol(s), were added. The mixture was heated to 80° C. HDI or a HDI/DCMDI mixture was then apportioned and a temperature was maintained so that the hot reaction mixture did not solidify. The reaction mixture was stirred until no free isocyanate could be detected (NCO content <0.1%). The hot melt was then discharged and allowed to cool and solidify.

The resultant solid polyurethane diols were in each case comminuted, ground and sieved by means of grinding and sieving methods conventional for the production of powder coatings and, in this manner, converted into binder powders with an average particle size of 50 μm (determined by means of laser diffraction).

The melting behavior of the polyurethane diols was investigated by means of DSC (differential scanning calorimetry, heating rate 10 K/min).

Examples 3a to 3f are shown in Table 3. The Table states which reactants were reacted together in what molar ratios and the final temperature of the melting process measured by DSC is stated in ° C.

TABLE 3

| | Mols | Mols | Mols | Mols | Mols | |
|---|---|---|---|---|---|---|
| Example | HDI | DCMDI | diol A | diol B | diol C | FT |
| 3a | 2 | | 2 PROP | 1 HEX | | 131° C. |
| 3b | 2 | | 1 PROP | 2 HEX | | 150° C. |
| 3c | 2 | | 3 PENT | | | 137° C. |
| 3d | 3 | | 1.33 | 1.33 PROP | 1.33 HEX | 118° C. |
| | | | PENT | | | |
| 3e | 2 | | 1 BPA | 2 HEX | | 149° C. |
| 3f | 1.5 | 0.5 | 3 PENT | | | 126° C. |

cf. Table 1 for abbreviations

### Examples 4a to 4b

### Preparation of Polyurethane Polyols

Polyurethane polyols were produced by reacting HDI or a mixture of HDI and DCMDI with a mixture of GLY (glycerol) and a diol in accordance with the following general synthesis method:

The polyols were initially introduced into a 2 litre four-necked flask equipped with a stirrer, thermometer and column and 0.01 wt. % dibutyltin dilaurate, relative to the initially introduced quantity of polyols, were added. The mixture was heated to 80° C. HDI or a HDI/DCMDI mixture was then apportioned and a temperature was maintained so that the hot reaction mixture did not solidify. The reaction mixture was stirred until no free isocyanate could be detected (NCO content <0.1%). The hot melt was then discharged and allowed to cool and solidify.

The resultant solid polyurethane polyols were in each case comminuted, ground and sieved by means of grinding and sieving methods conventional for the production of powder coatings and, in this manner, converted into binder powders with an average particle size of 50 μm (determined by means of laser diffraction).

The melting behavior of the polyurethane polyols was investigated by means of DSC (differential scanning calorimetry, heating rate 10 K/min).

Examples 4a to 4b are shown in Table 4. The Table states which reactants were reacted together in what molar ratios and the final temperature of the melting process measured by DSC is stated in ° C.

TABLE 4

| | | Mols | | Mols | |
|---|---|---|---|---|---|
| Example | Mols HDI | DCMDI | Mols GLY | Diol A | FT |
| 4a | 2 | | 1 | 2 HEX | 130° C. |
| 4b | 1.5 | 0.5 | 1 | 2 HEX | 117° C. |

cf. Table 1 for abbreviations

### Example 5

### Production of Bismuth Methanesulfonate

A mixture of 296 g of deionized water and 576 g (6 mol) of methanesulfonic acid was initially introduced and heated to 80° C. 466 g (1 mol) of bismuth oxide (Bi₂O₃) were added in portions while the mixture was stirred. After 3 hours, a turbid liquid is obtained which, on dilution with 5400 g of deionized water, gives rise to an opalescent solution. The residue left on evaporation of the solution is bismuth methanesulfonate.

### Example 6

### Production of a Blocked Polyisocyanate

2.75 mol of diphenylmethane diisocyanate and 233 g of methyl isobutyl ketone were weighed out into a reaction vessel and stirred at room temperature. Then 2.75 mol of diethylene glycol monobutyl ether were added in one hour with cooling. Once a constant NCO value had been reached, 1 mol of the 1:1 adduct obtained from propylene carbonate and diethanolamine and 4.1 g of dibutyltin dilaurate (catalyst) were added. The reaction mixture was kept at 50° C. until no free isocyanate could any longer be detected.

### Example 7a) to r)

### Production of CED Binders

a) A mixture of 666 g methoxypropanol, 319 g bisphenol A, 591 g of an adduct of 2 mol epoxy resin (based on bisphenol A/epichlorhydrine; epoxy equivalent weight 190) and 1 mol polypropylene glycol 400 and 886 g epoxy resin (based on bisphenol A/epichlorhydrine; epoxy equivalent weight 190) was heated to 45° C. and stirred for 1 hour. 121 g diethanolamine and 81.5 g dimethyl aminopropylamine were then added and the batch was stirred for 2 hours at 125° C. The methoxypropanol was then distilled off under vacuum and the batch was diluted with 240 g hexyl glycol to yield a solution of an aminoepoxy resin CED binder.

b) to i) The polyurethane powders obtained in Examples 1a) to d) and 2a) to d) were in each case thoroughly mixed into the solution obtained under a) in a solids weight ratio of 14.3 parts of the respective powder:100 parts of CED binder.

k) to r) The polyurethane powders obtained in Examples 3a) to f) and 4a) to b) were in each case thoroughly mixed into the solution obtained under a) in a solids weight ratio of 14.3 parts of the respective powder:100 parts of CED binder. Each mixture was heated to above the melting point of the respective polyurethane powder under stirring until a hot solution was obtained. Thereafter the hot solution was allowed to cool to 80° C. under stirring. After further cooling to room temperature in each case a solution of the aminoepoxy resin containing the respective finely dispersed solid polyurethane was obtained.

### Examples 8a) to r)

### Production of CED Clear Coats

Each of the aminoepoxy resin solutions 7a) to r) was mixed with the solution of the blocked polyisocyanate from Example 6 in a solids weight ratio of 70:30. Bismuth methanesulfonate (from Example 5) was added as catalyst corresponding to a content of 1.3 wt. % bismuth, relative to resin solids, and dilution was performed with formic acid and deionized water to yield a 12 wt. % CED clear coat with an acid content of 33 milliequivalents per 100 g of resin solids.

Degreased, unphosphated steel test sheets (Ra value=1.5 μm) were provided with a 20 μm thick CED coat from CED clear coat baths 8a to 8r (coating conditions: 2 minutes at 32° C. at a deposition voltage of 260 V; baking conditions: 20 minutes, 180° C. object temperature). The roughness of the baked CED clear coat layers was measured as an Ra value (DIN 4777, using T500 Lommel-Tester, cut-off 2.5 mm, 15 mm measurement path).

Perforated (perforation diameter 10 mm), degreased, unphosphated steel test sheets were also coated in an entirely similar manner and then exposed to salt spray conditions to DIN 50 021-SS for 144 hours. The edges of the perforations were evaluated for edge rusting (ratings KW 0 to 5: KW 0=no rust on edges; KW 1=isolated rust spots on edges; KW 2=rust spots on less than ⅓ of edges; KW 3=⅓ to ⅔ of edges covered with rust; KW 4=more than ⅔ of edges covered with rust; KW 5=edges completely rusty).

TABLE 5

| CED clear coat | Polyurethane | Edge rusting, | Roughness |
|---|---|---|---|
| under test | used | rating | (Ra value in μm) |
| 8a, Comparison | —/— | 4 | 0.43 |
| 8b | 1a | 2-3 | 0.41 |
| 8c | 1b | 2-3 | 0.40 |
| 8d | 1c | 3 | 0.41 |
| 8e | 1d | 4 | 0.42 |
| 8f | 2a | 3 | 0.41 |
| 8g | 2b | 3 | 0.41 |
| 8h | 2c | 4 | 0.42 |
| 8i | 2d | 3 | 0.41 |
| 8k | 3a | 2-3 | 0.40 |
| 8l | 3b | 2 | 0.39 |
| 8m | 3c | 2-3 | 0.40 |
| 8n | 3d | 3 | 0.40 |
| 8o | 3e | 2 | 0.39 |
| 8p | 3f | 4 | 0.42 |
| 8q | 4a | 2-3 | 0.40 |
| 8r | 4b | 3 | 0.42 |

What is claimed is:

1. CED coating compositions which, apart from water, comprise (i) a resin solids content consisting of at least one film-forming, self- or externally cross-linking CED binder and the optional components: cross-linkers, paste resins, nonionic resins, and (ii) optionally, at least one component selected from the group consisting of pigments, fillers, coating additives and organic solvents, and contain relative to the resin solids content thereof, 1 to 20 wt. % of at least one resin A with functional groups selected from the group consisting of hydroxyl groups, free isocyanate groups and blocked isocyanate groups, wherein the at least one resin A is present as particles with melting temperatures from 40 to 200° C.

2. The CED coating compositions of claim 1, wherein the proportion of the at least one resin A is 5 to 15 wt. %, relative to the resin solids content.

3. The CED coating compositions of claim 1 or 2, wherein the melting temperature of the at least one resin A is the upper end of a 30 to 150° C. broad melting range.

4. The CED coating compositions of any one of the preceding claims, wherein the solubility of the at least one resin A is less than 10 g per litre of butyl acetate or water at 20° C.

5. The CED coating compositions of any one of the preceding claims, wherein the average particle size of the resin A particles determined by means of laser diffraction is 1 to 100 μm.

6. The CED coating compositions of any one of the preceding claims, wherein the resin A particles have a non-spherical shape.

7. The CED coating compositions of any one of the preceding claims, wherein the resin A particles are formed by grinding of the at least one solid resin A or by hot dissolution of the at least one resin A in a dissolution medium and subsequent resin A particle formation during and/or after cooling.

8. The CED coating compositions of any one of the preceding claims having a CED binder/cross-linker system which allows for involvement of the at least one resin A in the chemical cross-linking process with its functional groups selected from the group consisting of hydroxyl groups, free isocyanate groups and blocked isocyanate groups during thermal curing of the coating layers cathodically deposited from the CED coating compositions.

9. The CED coating compositions of claim 8, wherein the CED binder/cross-linker system cross-links by the reaction of hydroxyl and/or secondary amino and/or primary amino groups with blocked isocyanate groups under formation of urethane and/or urea bonds.

10. The CED coating compositions of any one of the preceding claims, wherein the at least one resin A is a polyurethane resin with functional groups selected from the group consisting of hydroxyl groups, free isocyanate groups and blocked isocyanate groups.

11. The CED coating compositions of claim 10, wherein the polyurethane resin is a hydroxyl-functional polyurethane resin in the form of a polyurethane diol which can be prepared by reacting 1,6-hexane diisocyanate or 4,4′-diphenylmethane diisocyanate with a diol component in the molar ratio x:(x+1), wherein x means any desired value from 2 to 6, and the diol component is one single diol or a combination of diols.

12. The CED coating compositions of claim 10, wherein the polyurethane resin is a hydroxyl-functional polyurethane resin in the form of a polyurethane diol which can be prepared by reacting a diisocyanate component and bisphenol A or a diol component in the molar ratio x:(x+1), wherein x means any desired value from 2 to 6, wherein 50 to 80 mol % of the diisocyanate component is formed by 1,6-hexane diisocyanate, and 20 to 50 mol % by one or two diisocyanates, each forming at least 10 mol % of the diisocyanate component and being selected from the group consisting of toluoylene diisocyanate, diphenylmethane diisocyanate, dicyclohexylmethane diisocyanate, isophorone diisocyanate, trimethylhexane diisocyanate, cyclohexane diisocyanate, cyclohexanedimethylene diisocyanate and tetramethylenexylylene diisocyanate, wherein the mol % of the respective diisocyanates add up to 100 mol %, wherein 20 to 100 mol % of the diol component is formed by at least one linear aliphatic alpha,omega-C2-C12-diol, and 0 to 80 mol % by at least one diol that is different from linear aliphatic alpha,omega-C2-C12-diols, wherein the mol % of the respective diols add up to 100 mol %.

13. The CED coating compositions of claim 11 or 12, wherein a proportion of the dihydroxy compound(s) used for the synthesis of said polyurethane diol is replaced by a triol component comprising at least one triol.

14. The CED coating compositions of claim 10, wherein the polyurethane resin is an isocyanate-functional polyurethane resin in the form of a polyurethane diisocyanate which can be prepared by reacting 1,6-hexane diisocyanate or 4,4′-diphenylmethane diisocyanate with a diol component in the molar ratio (x+1):x, wherein x means any desired value from 2 to 6, and the diol component is one single diol or a combination of diols.

15. The CED coating compositions of claim 10, wherein the polyurethane resin is an isocyanate-functional polyurethane resin in the form of a polyurethane diisocyanate which can be prepared by reacting a diisocyanate component and bisphenol A or a diol component in the molar ratio (x+1):x, wherein x means any desired value from 2 to 6, wherein 50 to 80 mol % of the diisocyanate component is formed by 1,6-hexane diisocyanate, and 20 to 50 mol % by one or two diisocyanates, each forming at least 10 mol % of the diisocyanate component and being selected from the group consisting of toluoylene diisocyanate, diphenylmethane diisocyanate, dicyclohexylmethane diisocyanate, isophorone diisocyanate, trimethylhexane diisocyanate, cyclohexane diisocyanate, cyclohexanedimethylene diisocyanate and tetramethylenexylylene diisocyanate, wherein the mol % of the respective diisocyanates add up to 100 mol %, wherein 20 to 100 mol % of the diol component is formed by at least one linear aliphatic alpha,omega-C2-C12-diol, and 0 to 80 mol % by at least one diol that is different from linear aliphatic alpha,omega-C2-C12-diols, wherein the mol % of the respective diols add up to 100 mol.

16. The CED coating compositions of claim 10, wherein the polyurethane resin is an isocyanate-functional polyurethane resin in the form of a polyurethane polyisocyanate which can be prepared by reacting a trimer of a (cyclo)aliphatic diisocyanate, 1,6-hexane diisocyanate and bisphenol A or a diol component in the molar ratio 1:x:x, wherein x means any desired value from 1 to 6, wherein the diol component is one single linear aliphatic alpha,omega-C2-C12-diol or a combination of two to four diols, wherein in the case of a diol combination, each of the diols makes up at least 10 mol % of the diols of the diol combination and the diol combination consists of at least 80 mol % of bisphenol A or of at least one linear aliphatic alpha,omega-C2-C12-diol.

17. The CED coating compositions of claim 10, wherein the polyurethane resin is a polyurethane resin with two blocked isocyanate groups per molecule which can be prepared by reacting 1,6-hexane diisocyanate or 4,4′-diphenylmethane diisocyanate with a diol component and with at least one monofunctional blocking agent in the molar ratio x:(x−1):2, wherein x means any desired value from 2 to 6, and the diol component is one single diol or a combination of diols.

18. The CED coating compositions of claim 10, wherein the polyurethane resin is a polyurethane resin with two blocked isocyanate groups per molecule which can be prepared by reacting a diisocyanate component, bisphenol A or a diol component and at least one monofunctional blocking agent in the molar ratio x:(x−1):2, wherein x means any desired value from 2 to 6, wherein 50 to 80 mol % of the diisocyanate component is formed by 1,6-hexane diisocyanate, and 20 to 50 mol % by one or two diisocyanates, each forming at least 10 mol % of the diisocyanate component and being selected from the group consisting of toluoylene diisocyanate, diphenylmethane diisocyanate, dicyclohexylmethane diisocyanate, isophorone diisocyanate, trimethylhexane diisocyanate, cyclohexane diisocyanate, cyclohexanedimethylene diisocyanate and tetramethylenexylylene diisocyanate, wherein the mol % of the respective diisocyanates add up to 100 mol %, wherein 20 to 100 mol % of the diol component is formed by at least one linear aliphatic alpha,omega-C2-C12-diol, and 0 to 80 mol % by at least one diol that is different from linear aliphatic alpha,omega-C2-C12-diols, and wherein the mol % of the respective diols add up to 100 mol %.

19. The CED coating compositions of claim 10, wherein the polyurethane resin is a polyurethane resin with blocked isocyanate groups which can be prepared by reacting a trimer of a (cyclo)aliphatic diisocyanate, 1,6-hexane diisocyanate, bisphenol A or a diol component and at least one monofunctional blocking agent in the molar ratio 1:x:x:3, wherein x means any desired value from 1 to 6, wherein the diol component is one single linear aliphatic alpha,omega-C2-C12-diol or a combination of two to four diols, wherein in the case of diol combination, each of the diols makes up at least 10 mol % of the diols of the diol combination and the diol combination consists of at least 80 mol % of bisphenol A or of at least one linear aliphatic alpha,omega-C2-C12-diol.

20. A process for the production of a CED coating layer on an electrically conductive substrate, wherein a CED coating layer is cathodically deposited from a CED coating composition of any one of the preceding claims onto an electrically conductive substrate connected as the cathode, and baked at an object temperature above the melting temperature of the at least one resin A contained in the CED coating composition.

21. The process of claim 20, wherein the CED coating layer is selected from the group consisting of a single-layer coating and a coating layer within a multilayer coating.

22. The process of claim 20, wherein the electrically conductive substrate is selected from the group consisting of automotive parts, automotive bodies and automotive body parts.
